(19) United States
(12) Patent Application Publication
(10) Pub. No.: US 2025/0358842 A1
(43) Pub. Date: Nov. 20, 2025

(54) PREEMPTION OF SIDELINK RESOURCES IN UNLICENSED BANDS

(71) Applicant: QUALCOMM Incorporated, San Diego, CA (US)

(72) Inventors: Shaozhen GUO, Beijing (CN); Changlong XU, Beijing (CN); Chih-Hao LIU, San Diego, CA (US); Jing SUN, San Diego, CA (US); Xiaoxia ZHANG, San Diego, CA (US); Luanxia YANG, Beijing (CN); Siyi CHEN, Beijing (CN); Hao XU, Beijing (CN)

(21) Appl. No.: 18/871,986

(22) PCT Filed: Aug. 3, 2022
(86) PCT No.: PCT/CN2022/109859

§ 371 Date: Dec. 5, 2024

(51) Int. Cl. H04W 74/0808; H04W 72/25

(52) U.S. Cl. CPC H04W 74/0808; H04W 72/25

(57) ABSTRACT

Various aspects of the present disclosure generally relate to wireless communication. In some aspects, a first user equipment (UE) may transmit first sidelink control information (SCI) indicative of a first reservation of a sidelink resource corresponding to an unlicensed sidelink band. The UE may receive second SCI indicative of a second reservation of the sidelink resource. The UE may determine, based on at least one channel occupancy time (COT) associated with at least one of the first UE, the second UE, or an additional UE, a preemption status corresponding to the second reservation relative to the first reservation. The UE may perform a sidelink resource allocation operation based on the preemption status. Numerous other aspects are described.

### FIELD OF THE DISCLOSURE

Aspects of the present disclosure generally relate to wireless communication and to techniques and apparatuses for preemption of sidelink resources in unlicensed bands.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first user equipment may include a memory and one or more processors coupled to the memory. The one or more processors may be configured to transmit first sidelink control information (SCI) indicative of a first reservation of a sidelink resource corresponding to an unlicensed sidelink band. The one or more processors may be configured to receive second SCI indicative of a second reservation of the sidelink resource. The one or more processors may be configured to determine, based on at least one channel occupancy time (COT) associated with at least one of the first UE, the second UE, or an additional UE, a preemption status corresponding to the second reservation relative to the first reservation. The one or more processors may be configured to perform a sidelink resource allocation operation based on the preemption status.

Some aspects described herein relate to a method of wireless communication performed by a first UE. The method may include transmitting first SCI indicative of a first reservation, by the first UE for a first sidelink communication, of a sidelink resource corresponding to an unlicensed sidelink band. The method may include receiving second SCI indicative of a second reservation, by a second UE for a second sidelink communication, of the sidelink resource. The method may include determining, based on at least one COT associated with at least one of the first UE, the second UE, or an additional UE, a preemption status corresponding to the second reservation relative to the first reservation. The method may include performing a sidelink resource allocation operation based on the preemption status.

Some aspects described herein relate to an apparatus for wireless communication. The apparatus may include means for transmitting first SCI indicative of a first reservation, by the apparatus for a first sidelink communication, of a sidelink resource corresponding to an unlicensed sidelink band. The apparatus may include means for receiving second SCI indicative of a second reservation, by a UE for a second sidelink communication, of the sidelink resource. The apparatus may include means for determining, based on at least one COT associated with at least one of the apparatus, the UE, or an additional UE, a preemption status corresponding to the second reservation relative to the first reservation. The apparatus may include means for performing a sidelink resource allocation operation based on the preemption status.

Some aspects described herein relate to a non-transitory computer-readable medium that stores a set of instructions for wireless communication by a first UE. The set of instructions, when executed by one or more processors of the UE, may cause the UE to transmit first SCI indicative of a first reservation, by the first UE for a first sidelink communication, of a sidelink resource corresponding to an unlicensed sidelink band. The set of instructions, when executed by one or more processors of the UE, may cause the UE to receive second SCI indicative of a second reservation, by a second UE for a second sidelink communication, of the sidelink resource. The set of instructions, when executed by one or more processors of the UE, may cause the UE to determine, based on at least one COT associated with at least one of the first UE, the second UE, or an additional UE, a preemption status corresponding to the second reservation relative to the first reservation. The set of instructions, when executed by one or more processors of the UE, may cause the UE to perform a sidelink resource allocation operation based on the preemption status.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIGS. 4A-4C are diagrams illustrating examples associated with resource selection for sidelink communications, in accordance with the present disclosure.

FIG. 5 is a diagram illustrating an example associated with preemption of sidelink resources in unlicensed bands, in accordance with the present disclosure.

FIG. 6 is a diagram illustrating an example process performed, for example, by a first UE, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

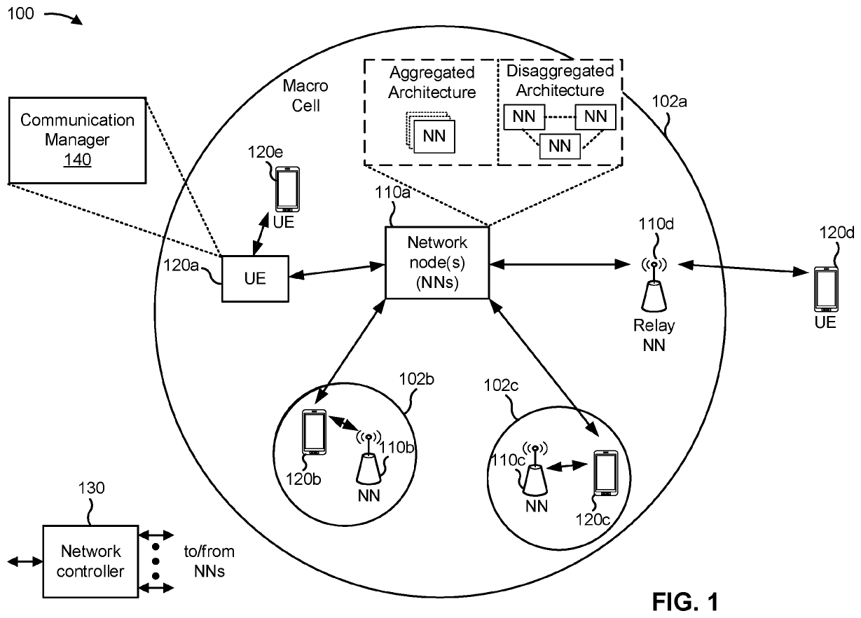

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit first sidelink control information (SCI) indicative of a first reservation of a sidelink resource corresponding to an unlicensed sidelink band; receive second SCI indicative of a second reservation of the sidelink resource; determine, based on at least one channel occupancy time (COT) associated with at least one of the first UE, the second UE, or an additional UE, a preemption status corresponding to the second reservation relative to the first reservation; and perform a sidelink resource allocation operation based on the preemption status. Additionally, or alternatively, the communication manager 140 may perform one or more other operations described herein.

As indicated above, FIG. 1 is provided as an example. Other examples may differ from what is described with regard to FIG. 1.

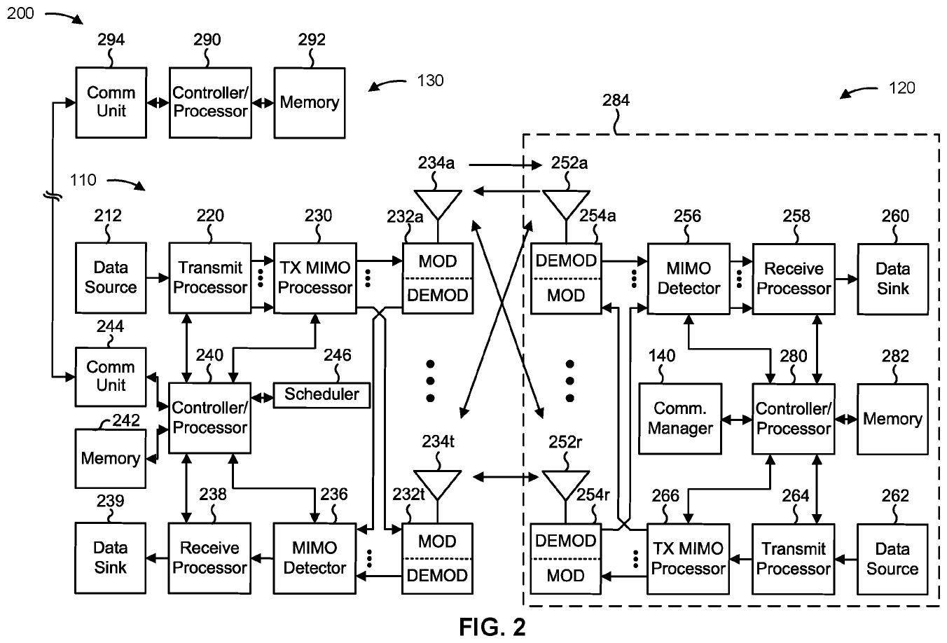

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

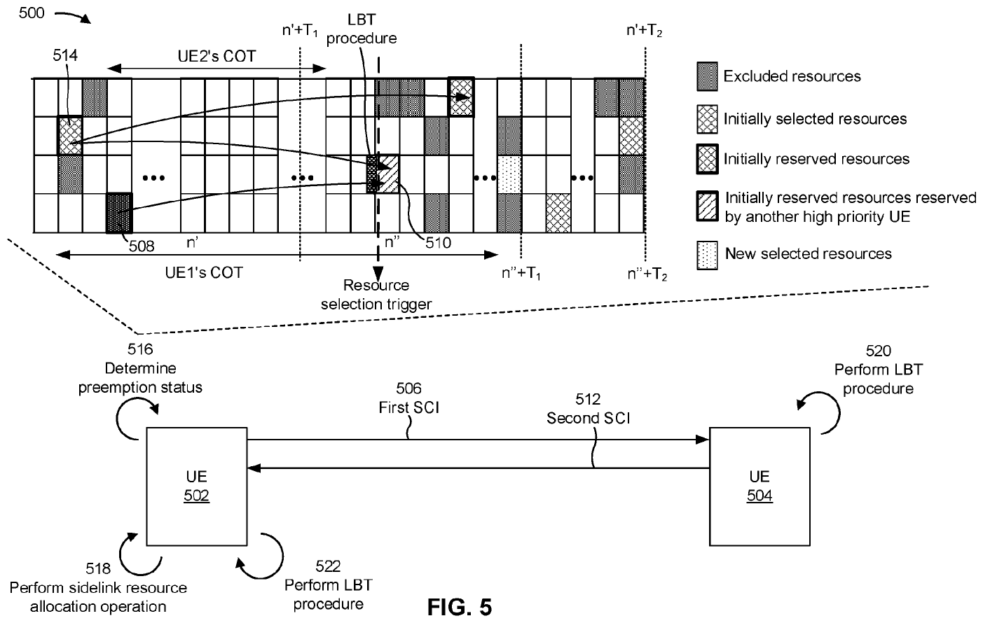

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-7).

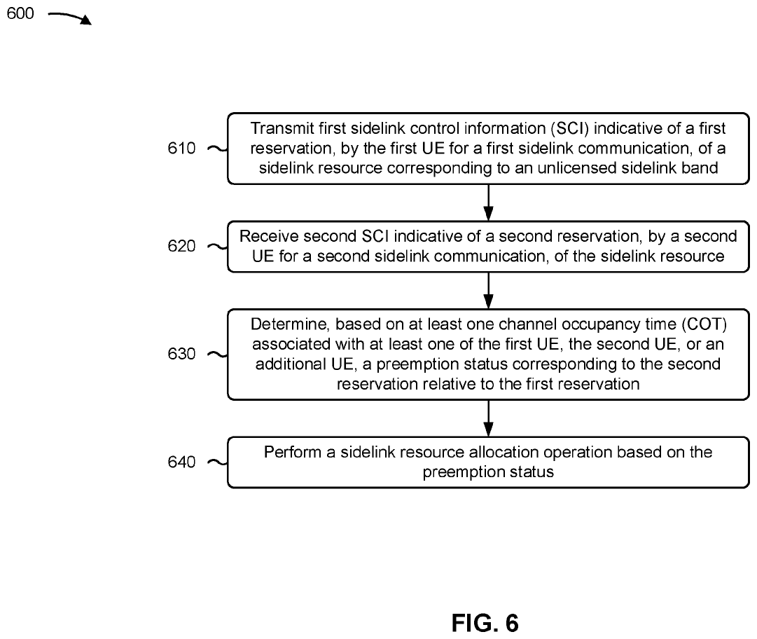

The controller/processor 240 of the network node 110, the controller/processor 280 of the UE 120, and/or any other component(s) of FIG. 2 may perform one or more techniques associated with preemption of sidelink resources in unlicensed bands, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, a first UE (e.g., the UE 120) includes means for transmitting first SCI indicative of a first reservation, by the first UE for a first sidelink communication, of a sidelink resource corresponding to an unlicensed sidelink band; means for receiving second SCI indicative of a second reservation, by a second UE for a second sidelink communication, of the sidelink resource; means for determining, based on at least one COT associated with at least one of the first UE, the second UE, or an additional UE, a preemption status corresponding to the second reservation relative to the first reservation; and/or means for performing a sidelink resource allocation operation based on the preemption status. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

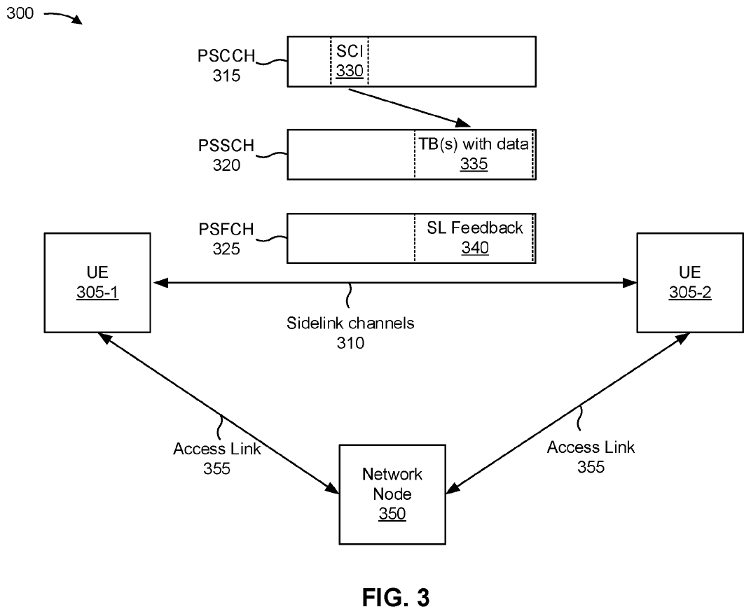

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

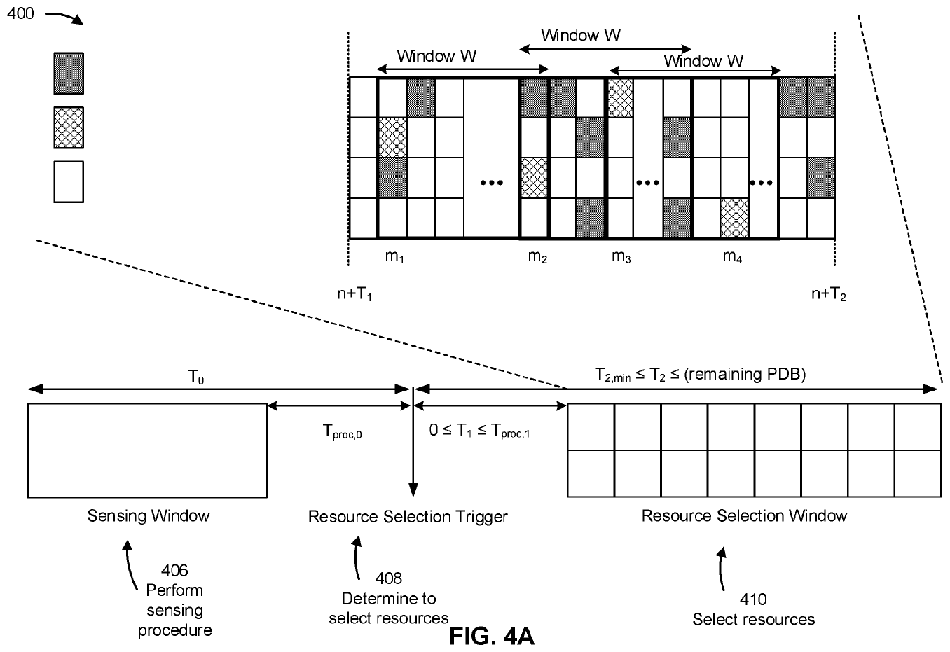

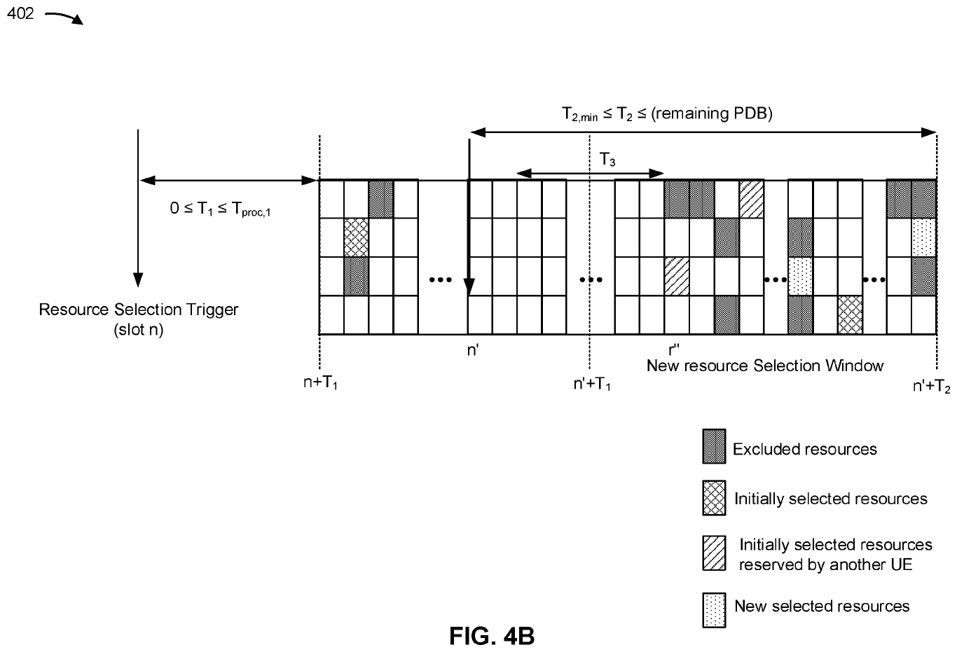

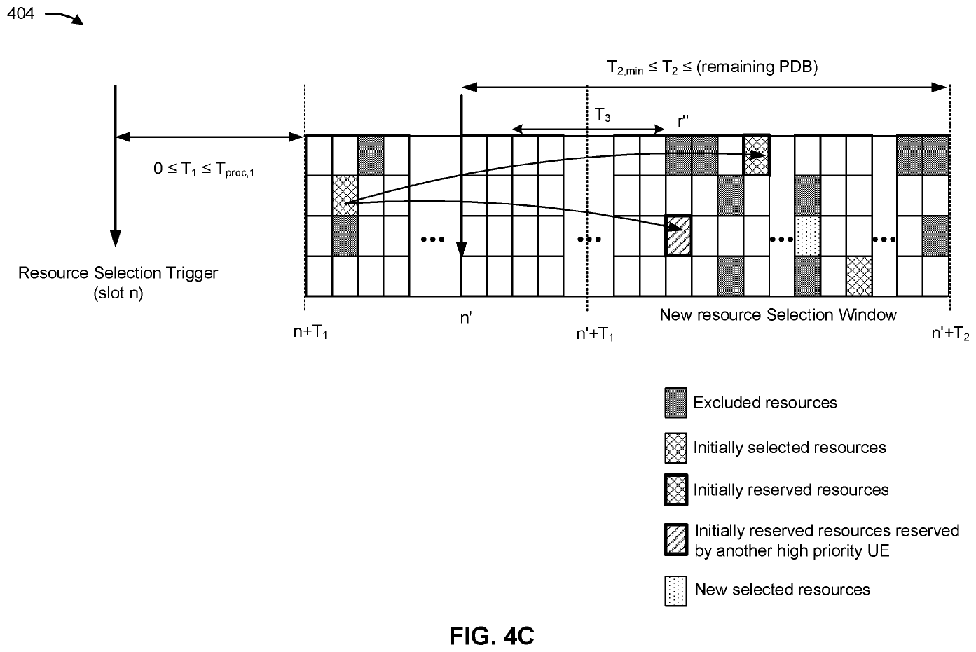

Additionally, or alternatively, as described in more detail in connection with FIGS. 4A-4C, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As shown, a network node 350 may communicate with the UE 305-1 and/or the UE 305-2 (e.g., directly or via one or more network nodes), such as via an access link 355. A direct link between the UEs 350-1 and 350-2 (e.g., via a PC5 interface) may be referred to as a sidelink, and a direct link between a network node 350 and a UE 350-1 or 350-2 (e.g., via a Uu interface) may be referred to as an access link. Sidelink communications may be transmitted via the sidelink, and access link communications may be transmitted via the access link. An access link communication may be either a downlink communication (from the network node 350 to the UE 350-1 or 350-2) or an uplink communication (from a UE 350-1 or 350-2 to the network node 350).

As indicated above, FIG. 3 is provided as an example. Other examples may differ from what is described with respect to FIG. 3.

FIGS. 4A-4C are diagrams illustrating examples 400, 402, and 404 associated with resource selection for sidelink communications, in accordance with the present disclosure. The example 400 shows a scheme for resource selection performed by a UE (e.g., the UE 350-1 and/or the UE 350-2 depicted in FIG. 3 and/or the UE 120 depicted in FIGS. 1 and 2). The scheme for resource selection can include sensing a sidelink channel, based on a resource selection window, for selecting resources for a sidelink communication. A UE can use a channel sensing procedure to select resources for sidelink communication, such as described above in connection with FIG. 3.

In Mode 2, resource selection may include two steps. In a first step, the UE can identify candidate resources using sensing procedures and/or exclusion procedures. In a second step, the UE can perform a resource selection procedure in which the UE selects candidate resources from the identified candidate resources. Selection can be performed by higher protocol stack layers using random selection.

As shown by reference number 406, the UE may perform a sensing procedure in a sensing window. The sensing window is the time interval defined by a range of slots [n−T₀, n−T_{proc,0}], where n is the resource selection (or reselection) trigger or slot at which new resources must be selected, T₀ is configured as 100 milliseconds (ms) (e.g., for aperiodic resource reservation, such as aperiodic reservation in one or more slots of up to 32 logical slots in the future) or 1100 ms (e.g., for periodic resource reservation), and T_{proc,0} is the time required to complete the sensing procedure. In some cases, a UE configured for communication in an NR network can use a sensing procedure for aperiodic or periodic resource reservation.

According to the channel sensing procedure, the UE can decode control messages relating to resource reservations of other UEs, as well as perform measurements (e.g., RSRP measurements and/or RSSI measurements, among other examples) associated with one or more sidelink channels. For example, UEs can transmit reservation information (e.g., in SCI) that indicates a resource reservation for a current slot (e.g., the slot in which the reservation information is transmitted) and for one or more (e.g., up to two) future slots. A resource allocation associated with a resource reservation may be one or more sub-channels in a frequency domain and one slot in a time domain. In some cases, a resource reservation may be aperiodic or periodic. In periodic resource reservation, a UE can signal (e.g., in the reservation information in SCI) a period for the resource reservation (e.g., a value between 0 ms and 1000 ms). In some cases, the sensing procedure can be performed by a physical layer of the UE based on a request from a medium access control (MAC) layer of the UE.

As shown by reference number 408, the UE can determine to select resources for a sidelink communication based at least in part on a resource selection trigger. For example, resource selection can be triggered when the UE has a packet that is to be transmitted or when the UE receives an indication to select (or reselect) resources for a packet that is to be transmitted by the UE. Based at least in part on the resource selection trigger, the UE can determine one or more resources that are available for selection in a resource selection window. That is, the UE can determine the one or more available resources based at least in part on the channel sensing procedure performed by the UE. For example, the channel sensing procedure may provide an indication of resources in the resource selection window that are occupied and/or resources in the resource selection window associated with high interference.

As shown, if the resource selection trigger occurs at a slot n, the resource selection window can be from n+T₁ to n+T₂. In some aspects, T₁ can be less than a processing time (T_{proc,1}) associated with the UE. In some aspects, T₂ can be greater than or equal to T₂,min, which can be a value configured for the UE based at least in part on a priority of the UE, and less than or equal to a remaining packet delay budget (PDB) of the packet to be transmitted by the UE. A PDB is a constraint dictating a maximum delay between a time of packet arrival and a time of a last transmission of the packet. For example, each packet that arrives at a transmitter of a UE for transmission by the transmitter is associated with a PDB and a quantity of transmissions (a quantity of times that the packet is to be transmitted). The PDB and the quantity of transmissions can vary among packets depending on, for example, an application or a service associated with the packet (e.g., in order to achieve a desired coverage, range, reliability, and/or the like).

The resource selection window can include all the resources within the range of slot [n+T₁, n+T₂]. The UE can exclude resources in the resource selection window, as shown. In some cases, the UE can exclude resources related to half-duplex operation since a half-duplex UE cannot sense the reservations from other UEs announced in the slot of the sensing window where the UE was transmitting. In some cases, the UE can exclude candidate resources based on the reservations reserved from other UEs in SCI-1 transmissions detected during the sensing window.

The physical layer of the UE can report the set of candidate resources to the MAC layer of the UE. The MAC layer randomly chooses for transmission one or more resources of the set of candidate resources reported. In some cases, the UE can be reserving resources for a HARQ transmission and/or retransmission, and the resources for multiple PSSCHs for the same transmission block can be randomly selected by the MAC layer.

As shown by reference number 410, the UE can select resources in the resource selection window. In some cases, the MAC layer of the UE can randomly select the sidelink resources from the available candidate resources reported by the physical layer of the UE. To select N candidate resources from the available candidate resources, the UE can first randomly select one of the N candidate resources. For example, the first candidate resource can be selected in slot m₁. Then, the UE can also randomly select second candidate resources, with the restriction that the gap between a second candidate resource and the first selected candidate resource must be smaller than a window W of 32 slots. In this way, the second candidate resources should be located (e.g., in slot m₂) within the range of slots [m₁−31, m₁+31]. If Nis larger than 2, the UE can select a third candidate resource but with the restriction that it is located (e.g., in slot m₃) within the range [m₁−31, m₁+31] or [m₂−31, m₂+31]. The above procedure can be repeated until all N candidate resources are selected.

In some cases, SCI can reserve resources for one, two, or three transmissions. A maximum number of reservations can be configured or preconfigured (e.g., specified in a wireless communication standard). In some cases, all reservations can be for the same number of sub-channels. A starting sub-channel can differ between reservations. In some cases, a transmitter UE can request feedback for a given transmission. In some cases, the transmitter UE can elect to not use a reservation based on feedback from other UEs. The reservations in can be repeated with the signaled period when enabled.

If a MAC layer of a UE requests the UE to determine a subset of resources from which the higher layer will select resources for PSSCH/PSCCH transmission as part of a re-evaluation or pre-emption procedure, the higher layer can provide a set of resources (r₀, r₁, r₂, . . . ) which can be subject to re-evaluation and a set of resources (r′₀, r′₁, r′₂, . . . ) which can be subject to preemption. UEs can be configured to determine the subset of resources (as requested by higher layers) before or after the slot r″ᵢ-T₃ (e.g., in slot n′), where r″ᵢ is the slot with the smallest slot index among (r₀, r₁, r₂, . . . ) and (r′₀, r′₁, r′₂, . . . ), and T₃ is equal to

$${T}_{proc , 1}^{SL} ,$$

where

$${T}_{proc , 1}^{SL}$$

is defined in slots according to a wireless communication standard, and where μ_{SL} is the subcarrier spacing (SCS) configuration of the sidelink bandwidth part (BWP).

In some cases, as shown in example 402 of FIG. 4B, a selected, but not yet reserved, resource could be reserved by another UE. In this case, the resource selection procedure (for re-evaluation) can be triggered. If a subset of selected but not yet reserved resources (e.g., M resources) are indicated for re-evaluation by the physical layer of the UE, the MAC layer of the UE can remove the M resources from the N candidate resources and randomly select M new candidate resources from the available candidate resources within a new selection window.

Sidelink transmissions (which may be referred to herein, interchangeably, as “communications”) may have associated priority levels. In some cases, a UE that has a communication with a higher priority level than, or a same priority level as, a priority level of a communication by another UE may preempt the other UE's resource reservation. For example, a first transmitter UE may reserve a sidelink resource for a communication having a first priority level. A transmitter UE is a UE that transmits a communication, is planning to transmit a communication, is capable of transmitting a communication, and/or the like. A second transmitter UE may reserve the same sidelink resource for a communication having a second priority level. If the second priority level is higher than, or the same as, the first priority level, the second transmitter UE's communication may preempt the first UE's communication, in which case the second transmitter UE may transmit using the reserved resource, while the first transmitter UE does not transmit using that resource. This concept of preemption may facilitate transmission of higher priority transmissions when multiple UEs compete for the same resources.

As shown in example 404, of FIG. 4C, if a resource satisfies a set of conditions, the physical layer of the UE can report pre-emption of this resource to the MAC layer of the UE. In some cases, the resource satisfies the set of conditions when the resource is reserved by another UE (with priority of prio_{RX}), and the priority prio_{RX} satisfies one of two priority conditions. The first priority condition (condition 1) can indicate that sl-PreemptionEnable is provided and is equal to ‘enabled’ and prio_{TX}>prio_{RX}, since a higher priority value (e.g., prio_{RX}, prio_{TX}) corresponds to a lower priority level. The second priority condition can indicate that sl-PreemptionEnable is provided and is not equal to ‘enabled’, and prio_{RX}<prioₚᵣₑ and prio_{TX}>prio_{RX}, wherein prioₚᵣₑ is a priority threshold configured by sl-PreemptionEnable. If a subset of reserved resources (e.g., M_{R} resources) are indicated for pre-emption by the physical layer of the UE, the MAC layer of the UE can remove the M_{R} reserved resources and randomly select M_{R} new candidate resources from the available candidate resources within the new selection window.

Some aspects described herein relate to an unlicensed radio frequency spectrum band, which may be used for communications in a wireless network, such as wireless network 100. In some aspects, the unlicensed radio frequency spectrum band can be used by network nodes 110 and UEs 120 of a cellular network for cellular communications (e.g., NR communications), and/or by Wi-Fi access points and Wi-Fi stations of a Wi-Fi network for Wi-Fi communications, among other examples. The unlicensed radio frequency spectrum band can be used in the cellular network in combination with, or independent from, a licensed radio frequency spectrum band. In some examples, the unlicensed radio frequency spectrum band can be a radio frequency spectrum band for which a device may need to contend for access because the radio frequency spectrum band is available, at least in part, for unlicensed use, such as Wi-Fi use.

Prior to gaining access to, and communicating over, an unlicensed sidelink radio frequency spectrum band, a UE can perform a listen-before-talk (LBT) procedure to contend for access to the unlicensed radio frequency spectrum band. An LBT procedure, sometimes referred to as a clear channel assessment (CCA) procedure, can include performing a CCA to determine whether a channel of the unlicensed sidelink radio frequency spectrum band is available. When it is determined that the channel of the unlicensed sidelink radio frequency spectrum band is not available (e.g., because another apparatus is already using the channel of the unlicensed sidelink radio frequency spectrum band), a CCA procedure can be performed for the channel again at a later time. In environments in which a UE can be starved of access to a channel of an unlicensed sidelink radio frequency spectrum band due to Wi-Fi activity, an extended CCA procedure can be employed to increase the likelihood that the UE will successfully contend for access to the channel of the unlicensed sidelink radio frequency spectrum band. An extended CCA procedure involves the performance of a random number of CCA procedures (from 1 to q), in accordance with an extended CCA counter.

Regardless of whether a single CCA procedure is performed or multiple CCA procedures are performed, each CCA procedure may include detecting or sensing an energy level on the channel of the unlicensed sidelink radio frequency spectrum band and determining whether the energy level is below a threshold. When the energy level is below the threshold, the CCA procedure is successful and contention to access the channel of the unlicensed sidelink radio frequency spectrum band may be successful. When the energy level exceeds the threshold, the CCA procedure is unsuccessful and contention to access the channel of the unlicensed sidelink radio frequency spectrum band may be unsuccessful.

When a CCA procedure or extended CCA procedure is successful, a transmission may be made over the channel of the unlicensed sidelink radio frequency spectrum band. When a packet error is encountered (e.g., due to a collision of transmissions made by two or more transmitting apparatuses or due to poor channel conditions), a HARQ-based retransmission can be performed. In some examples, the retransmission can be modified from the original transmission using rate adaptation (e.g., based at least in part on a CQI reported by a UE).

An LBT category can define a channel sensing duration during which a UE contending for access to a channel performs a CCA procedure. The channel sensing duration can indicate a length of time during which the UE detects or senses an energy level on the channel to determine whether the energy level is less than (or equal to) a threshold. If the energy level is less than (or equal to) the threshold, then the LBT/CCA procedure is successful, and the UE transmits a communication. If the energy level is greater than (or equal to) the threshold, then the CCA procedure is unsuccessful and the UE can wait for a period of time (e.g., a backoff duration) before performing the CCA procedure again.

Example LBT categories include category one (Cat 1) LBT, category two (Cat 2) LBT, category three (Cat 3) LBT, and category four (Cat 4) LBT. In Cat 1 LBT, also referred to as no LBT, an LBT procedure is not performed prior to transmission of a communication on the channel. In Cat 2 LBT, the channel sensing duration is fixed (e.g., without random back-off). For example, a 16 microsecond (μs) channel sensing duration is used for 16 μs Cat 2 LBT, and a 25 μs channel sensing duration is used for 25 μs Cat 2 LBT. In Cat 3 LBT, the channel sensing duration is fixed (e.g., a contention window has a fixed size), and random back-off is used. In Cat 4 LBT, the channel sensing duration is variable (e.g., a contention window has a variable size), and random back-off is used.

In Cat 4 LBT, the channel sensing duration can be variable depending on whether the UE contending for access to the channel senses interference (e.g., an energy level greater than or equal to a threshold). Using a Cat 4 LBT procedure, the UE can select a minimum channel sensing duration, which can be defined by a channel access priority class (CAPC) associated with the Cat 4 LBT procedure being used by the UE. For example, four different CAPCs can be associated with Cat 4 LBT, with the lowest CAPC value (e.g., CAPC 0) being associated with the highest priority for Cat 4 LBT (e.g., the shortest contention window size and shortest back-off duration), and the highest CAPC value (e.g., CAPC 3) being associated with the lowest priority for Cat 4 LBT (e.g., the longest contention window size and longest back-off duration). Generally, a higher CAPC value (e.g., a higher CAPC index) is associated with a lower priority. In Cat 4 LBT, if the UE detects interference in the minimum channel sensing duration for a CCA procedure as defined by a CAPC for the Cat 4 LBT procedure, then the UE can increase the channel sensing duration for the next CCA procedure.

Unlicensed sidelink bands in NR (NR-U) can have specified following channel access types. In a type 1 channel access, a time duration spanned by the sensing slots that are sensed to be idle before a transmission is random (Cat 4 LBT). In type 2 channel access, a time duration spanned by sensing slots that are sensed to be idle before a transmission is deterministic. In a type 2A channel access, a sensing duration of 25 μs (Cat 2 LBT) is used. In a type 2B, a sensing duration of 16 μs (Cat 2 LBT) is used. In a type 2C channel access, no sensing is used (Cat 1 LBT may be applied when the gap is no larger than 16 μs). In NR-U a network node can initiate a COT based on type 1 channel access. A UE can share the COT. In some cases, the UE can perform type 2 channel access before intended transmissions and the UE can transmit if the type 2 channel access is successful.

For sidelink on an unlicensed band (SL-U), based on the regulation requirements for unlicensed band, a device performs an LBT procedure. Different LBT types can be used depending on whether the transmission is within a COT or outside a COT. For transmissions outside of the COT (out-COT transmissions), Cat4 LBT is used, and for transmissions in the COT (in-COT transmission), Cat2 LBT or Cat1 LBT can be used. Since the sensing duration for different LBT types are different, the LBT pass probability for different LBT types are different. In general, the LBT probability for in-COT transmission can be higher than out-COT transmission.

In sidelink operation in a licensed band, a reserved resource for a UE can be preempted by another higher priority UE. However, for SL-U, the reserved resource can be out of a COT associated with the high priority UE. In this case, even if the reserved resource is preempted, the high priority UE may not be able to use this reserved resource due to LBT failure. On the other hand, the initially reserved resource can be within a COT of the low priority UE. However, after pre-emption, the new selected resource may be out of the COT. In this case, the transmission probability in the new selected resource can be reduced compared with the initially reserved resource, thereby decreasing channel access reliability in sidelink over unlicensed bands, reducing efficiency of sidelink communications over unlicensed bands, and resulting in collisions of sidelink communications over unlicensed bands.

Some aspects of the techniques and apparatuses described herein provide for COT-dependent pre-emption for sidelink over unlicensed bands. In some aspects, a first UE may transmit first SCI indicative of a first reservation, by the first UE for a first sidelink communication, of a sidelink resource corresponding to an unlicensed sidelink band. The UE may receive second SCI indicative of a second reservation, by a second UE for a second sidelink communication, of the sidelink resource. The UE may determine, based on at least one COT associated with at least one of the first UE, the second UE, or an additional UE, a preemption status corresponding to the second reservation relative to the first reservation. The UE may perform a sidelink resource allocation operation based on the preemption status. As a result, aspects of the techniques and apparatuses described herein may increase channel access reliability in sidelink over unlicensed bands, increase efficiency of sidelink communications over unlicensed bands, and reduce collisions of sidelink communications over unlicensed bands.

As indicated above, FIGS. 4A-4C are provided as examples. Other examples may differ from what is described with respect to FIGS. 4A-4C.

FIG. 5 is a diagram illustrating an example 500 associated with preemption of sidelink resources in unlicensed bands, in accordance with the present disclosure. As shown, a UE 502 and a UE 504 may communicate with one another. The UE 502 and the UE 504 may communicate with one another via an unlicensed sidelink band. In some aspects, the UE 502 and/or the UE 504 may be, be similar to, include, or be included in, the UE 305-1 and/or the UE 305-2 depicted in FIG. 3, and/or the UE 120 depicted in FIGS. 1 and 2.

As shown by reference number 506, the UE 502 may transmit first SCI 514. The UE 504 may receive the first SCI 514. In some aspects, any number of other sidelink UEs also may receive the first SCI 514. The first SCI 514 may be indicative of a first reservation of a sidelink resource 510 corresponding to an unlicensed sidelink band. As shown by reference number 512, the UE 504 may transmit, and the UE 502 may receive, second SCI 508. The second SCI 508 may be indicative of a second reservation of the sidelink resource 510.

As shown by reference number 516, the UE 502 may determine a preemption status corresponding to the first reservation relative to the second reservation. For example, the UE 502 may determine the preemption status based on at least one COT associated with at least one of the UE 502, the UE 504, or an additional UE. The preemption status may indicate preemption or no preemption. That is, for example, in some aspects, the first reservation may be preempted by the second reservation (e.g., a preemption status of “preempted”) or the first reservation may not be preempted by the second reservation (e.g., a preemption status of “not preempted”). In some aspects, the first reservation may be preempted by the second reservation based on at least one preemption condition being satisfied.

In some aspects, for example, the sidelink resource 510 may not be within (e.g., may be outside) the at least one COT, where the at least one COT consists of every COT associated with the UE 502 and every COT shared by the UE 502. A priority of the first sidelink communication may have a first priority level and a priority of the second sidelink communication may have a second priority level. The UE 502 may be configured with a sidelink preemption enablement parameter, and the at least one preemption condition may be satisfied based on the sidelink preemption enablement parameter having a first value and the second priority level being higher than the first priority level. In some aspects, the at least one preemption condition may be satisfied based on the sidelink preemption enablement parameter having a third priority level, the second priority level being higher than the first priority level, and the second priority level being higher than the third priority level.

For example, in some aspects, the UE 502 may apply a rule to determine the preemption status. The rule may state, for example, that if a reserved resource of a first UE (e.g., UE 502) is not in the first UE's COT or not in a shared COT of any other UEs, the existing conditions for preemption are applied. The rule may further state that the physical layer of the first UE reports preemption of the reserved resource to the MAC layer of the first UE if the following conditions are satisfied: the reserved resource of the first UE is reserved by a second UE (e.g., UE 504) with priority of prio_{RX}, and the priority prio_{RX} satisfies one of the following conditions: condition 1: sl-PreemptionEnable is provided and is equal to ‘enabled’ and prio_{TX}>prio_{RX}; or condition 2: sl-PreemptionEnable is provided and is not equal to ‘enabled’, and prio_{RX}<prioₚᵣₑ and prio_{TX}>prio_{RX}, wherein prioₚᵣₑ is the priority level configured by sl-PreemptionEnable.

In some aspects, the sidelink resource 510 may be neither in UE 502's COT nor in any shared COT of other UEs. The sidelink resource 510 may be preempted by a higher priority UE if a preemption condition is satisfied. For example, in some aspects, the sidelink resource 510 may be included in the at least one COT, where the at least one COT includes at least one of a COT associated with the UE 502 or a COT shared by the UE 502. If the UE 502 is configured with a sidelink preemption enablement parameter, the at least one preemption condition may be satisfied based on the sidelink preemption enablement parameter having a first value, and the second priority level being higher than the first priority level. In some aspects, the at least one preemption condition may be satisfied based on the sidelink preemption enablement parameter having a third priority level, the second priority level being higher than the first priority level, and the second priority level being higher than the third priority level.

For example, in some aspects, the UE 502 may apply a rule to determine the preemption status. The rule may state, for example, that if a reserved resource of a first UE (e.g., UE 502) is in the first UE's COT or in a shared COT of any other UEs, the existing conditions for preemption are applied. The rule may further state that the physical layer of the first UE reports preemption of the reserved resource to the MAC layer of the first UE if the following conditions are satisfied: the reserved resource of the first UE is reserved by a second UE (e.g., UE 504) with priority of prio_{RX}, and the priority prio_{RX} satisfies one of the following conditions: condition 1: sl-PreemptionEnable is provided and is equal to ‘enabled’ and prio_{TX}>prio_{RX} or condition 2: sl-PreemptionEnable is provided and is not equal to ‘enabled’, and prio_{RX}<prioₚᵣₑ and prio_{TX}>prio_{RX}, where prioₚᵣₑ is the priority level configured by sl-PreemptionEnable.

In some aspects, the at least one preemption condition may be satisfied based on the sidelink resource 510 being included in the at least one COT, where the at least one COT comprises at least one of a COT associated with the UE 504 or a COT shared by the UE 504. In some aspects, the second SCI may include a dedicated data field that indicates that the sidelink resource is in the at least one COT.

As shown by reference number 518, the UE 502 may perform a sidelink resource allocation operation based on the preemption status. In some aspects, for example, UE 502 may perform the sidelink resource allocation operation based on the first reservation being preempted by the second reservation. In case of preemption, the MAC layer of the UE 502 may remove the reserved sidelink resource 510 and randomly select a new candidate resource from the available candidate resources within a new selection window, where the new selected candidate resource is also in the COT of the UE 502 or in a shared COT of another UE. If there are no available candidate resources within the COT of the UE 502 or in a shared COT of another UE, the UE 502 may randomly select a new candidate resource from the available candidate resources within the new selection window. For example, the UE 502 may randomly select a new candidate resource that is outside at least one of a COT associated with the UE 502 or a COT shared by the UE 502.

In some aspects, the UE 502 may perform the sidelink resource allocation operation based on the first reservation not being preempted by the second reservation. For example, in some aspects, the first reservation may not be preempted by the second reservation based on the sidelink resource 510 being outside the at least one COT, wherein the at least one COT consists of every COT associated with the UE 504 and every COT shared by the UE 504. In some aspects, if the first reservation is not preempted by the second reservation, the first sidelink communication and the second sidelink communication may both be communicated using the sidelink resource 510.

To avoid transmission collision between these two communications, some aspects may provide for configuring different starting points for the different communications. For example, in some aspects, different starting points may be predefined or configured for the UE 502 and the UE 504. In some aspects, the first sidelink communication may be associated with a first starting time and the second sidelink communication may be associated with a second starting time. In some aspects, the second starting time may correspond to a beginning of the sidelink resource 510, and the first starting time may correspond to an offset from the beginning of the sidelink resource 510.

As shown by reference number 520, the UE 504 may perform an LBT procedure. If the LBT procedure yields a successful result (which may be referred to as “passing”) for the UE 504, the UE 504 may transmit during the offset, which will block the channel access of the UE 504. For example, the second sidelink communication may correspond to a transmission time that at least partially overlaps the offset based on a successful LBT procedure associated with the UE 504. In some aspects, as shown by reference number 522, the UE 502 may perform an LBT procedure, and the UE 502 may transmit, based on a successful result of the LBT, a partial automatic gain control (AGC) symbol in a first symbol of the sidelink resource 510. In some aspects, for example, if 25 μs Cat2 LBT is selected, then the offset can be any values or a subset of values between [9 μs, 25 μs] and if 16 μs Cat2 LBT is selected, then the offset can be any values or a subset of values between [9 μs, 16 μs].

In some aspects, the resource selection procedure may be triggered in a reference slot, and the UE 502 may identify a set of candidate resources in a resource selection window comprising a window opening time and a window closing time, where the window opening time corresponds to a first time period after the reference slot and the window closing time corresponds to a second time period after the reference slot. The second time period may have a length that is no smaller than a minimum value and no larger than a remaining PDB. For example, if LBT fails for the transmission of the UE 502 in the sidelink resource 510, the resource selection procedure may be triggered again. If the resource selection is triggered in slot n″, the physical layer of the UE 502 may identify available candidate resources in a new resource selection window [n″+T₁, n″+T₂] and report available candidate resources in the new selection window to the MAC layer of the UE 502, where T₂ may be configured based on UE implementation but within the range of T₂, min≤T₂≤remaining PDB.

As indicated above, FIG. 5 is provided as an example. Other examples may differ from what is described with respect to FIG. 5.

FIG. 6 is a diagram illustrating an example process 600 performed, for example, by a first UE, in accordance with the present disclosure. Example process 600 is an example where the UE (e.g., UE 502) performs operations associated with preemption of sidelink resources in unlicensed bands.

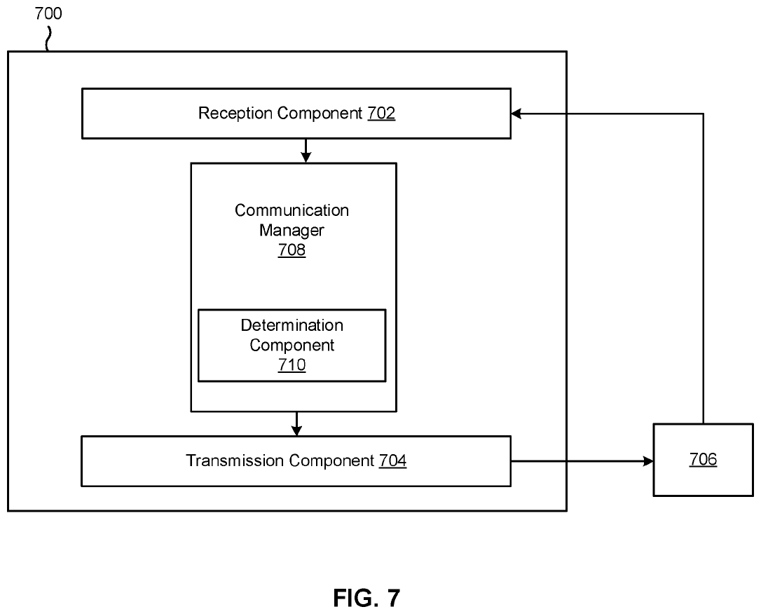

As shown in FIG. 6, in some aspects, process 600 may include transmitting first SCI indicative of a first reservation of a sidelink resource corresponding to an unlicensed sidelink band (block 610). For example, the UE (e.g., using communication manager 708 and/or transmission component 704, depicted in FIG. 7) may transmit first SCI indicative of a first reservation of a sidelink resource corresponding to an unlicensed sidelink band, as described above.

As further shown in FIG. 6, in some aspects, process 600 may include receiving second SCI indicative of a second reservation of the sidelink resource (block 620). For example, the UE (e.g., using communication manager 708 and/or reception component 702, depicted in FIG. 7) may receive second SCI indicative of a second reservation of the sidelink resource, as described above.

As further shown in FIG. 6, in some aspects, process 600 may include determining, based on at least one COT associated with at least one of the first UE, the second UE, or an additional UE, a preemption status corresponding to the second reservation relative to the first reservation (block 630). For example, the UE (e.g., using communication manager 708 and/or determination component 710, depicted in FIG. 7) may determine, based on at least one COT associated with at least one of the first UE, the second UE, or an additional UE, a preemption status corresponding to the second reservation relative to the first reservation, as described above.

As further shown in FIG. 6, in some aspects, process 600 may include performing a sidelink resource allocation operation based on the preemption status (block 640). For example, the UE (e.g., using communication manager 708, reception component 702, and/or transmission component 704, depicted in FIG. 7) may perform a sidelink resource allocation operation based on the preemption status, as described above.

Process 600 may include additional aspects, such as any single aspect or any combination of aspects described below and/or in connection with one or more other processes described elsewhere herein.

In a first aspect, performing the sidelink resource allocation operation based on the preemption status comprises performing the sidelink resource allocation operation based on the first reservation being preempted by the second reservation. In a second aspect, alone or in combination with the first aspect, the first reservation is preempted by the second reservation based on at least one preemption condition being satisfied.

In a third aspect, alone or in combination with the second aspect, the sidelink resource is not within the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on the sidelink preemption enablement parameter having a first value, and the second priority level being higher than the first priority level. In a fourth aspect, alone or in combination with the second aspect, the sidelink resource is outside the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on the sidelink preemption enablement parameter having a third priority level, the second priority level being higher than the first priority level, and the second priority level being higher than the third priority level.

In a fifth aspect, alone or in combination with the second aspect, the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on the sidelink preemption enablement parameter having a first value, and the second priority level being higher than the first priority level. In a sixth aspect, alone or in combination with the second aspect, the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on the sidelink preemption enablement parameter having a third priority level, the second priority level being higher than the first priority level, and the second priority level being higher than the third priority level.

In a seventh aspect, alone or in combination with one or more of the second through sixth aspects, the at least one preemption condition is satisfied based on the sidelink resource being included in the at least one COT, wherein the at least one COT comprises at least one of a COT associated with the second UE or a COT shared by the second UE. In an eighth aspect, alone or in combination with the seventh aspect, the second SCI comprises a dedicated data field that indicates that the sidelink resource is in the at least one COT.

In a ninth aspect, alone or in combination with one or more of the first through eighth aspects, performing the sidelink resource allocation operation comprises removing the sidelink resource from a first resource selection window based on the sidelink resource being preempted by the second UE, and determining a selected resource from a set of candidate resources in a second resource selection window, wherein the selected resource is included in the at least one COT, wherein the at least one COT comprises at least one of a COT associated with the first UE or a COT shared by the first UE.

In a tenth aspect, alone or in combination with one or more of the first through ninth aspects, performing the sidelink resource allocation operation comprises removing the sidelink resource from a first resource selection window based on the reserved resource being preempted by the second UE, and determining a selected resource from a set of candidate resources in a second resource selection window, wherein the selected resource is outside the at least one COT, wherein the at least one COT comprises at least one of a COT associated with the first UE or a COT shared by the first UE. In an eleventh aspect, alone or in combination with the second aspect, performing the sidelink resource allocation operation based on the preemption status comprises performing the sidelink resource allocation operation based on the first reservation not being preempted by the second reservation. In a twelfth aspect, alone or in combination with the eleventh aspect, the first reservation is not preempted by the second reservation based on the sidelink resource being outside the at least one COT, wherein the at least one COT consists of every COT associated with the second UE and every COT shared by the second UE.

In a thirteenth aspect, alone or in combination with one or more of the first through twelfth aspects, the first sidelink communication is associated with a first starting time and the second sidelink communication is associated with a second starting time. In a fourteenth aspect, alone or in combination with the thirteenth aspect, the second starting time corresponds to a beginning of the sidelink resource and wherein the first starting time corresponds to an offset from the beginning of the sidelink resource. In a fifteenth aspect, alone or in combination with the fourteenth aspect, the second sidelink communication corresponds to a transmission time that at least partially overlaps the offset based on a successful listen before talk procedure associated with the second UE.

In a sixteenth aspect, alone or in combination with one or more of the first through fifteenth aspects, process 600 includes performing an LBT procedure, wherein performing the sidelink resource allocation operation comprises transmitting, based on a successful result of the LBT, a partial automatic gain control symbol in a first symbol of the sidelink resource. In a seventeenth aspect, alone or in combination with one or more of the first through sixteenth aspects, process 600 includes performing an LBT procedure, and performing a resource selection procedure based on an unsuccessful result of the LBT procedure.

In an eighteenth aspect, alone or in combination with the seventeenth aspect, the resource selection procedure is triggered in a reference slot, the method further comprising identifying a set of candidate resources in a resource selection window comprising a window opening time and a window closing time, wherein the window opening time corresponds to a first time period after the reference slot and the window closing time corresponds to a second time period after the reference slot, and wherein the second time period has a length that is no smaller than a minimum value and no larger than a remaining packet delay budget, and determining a selected resource from the set of candidate resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708. The communication manager 708 may include a determination component 710.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 708 and/or the transmission component 704 may transmit first SCI indicative of a first reservation of a sidelink resource corresponding to an unlicensed sidelink band. In some aspects, the communication manager 708 may include one or more antennas, a modem, a controller/processor, a memory, or a combination thereof, of the UE described in connection with FIG. 2. In some aspects, the communication manager 708 may include the reception component 702 and/or the transmission component 704. In some aspects, the communication manager 708 may be, be similar to, include, or be included in, the communication manager 140 depicted in FIGS. 1 and 2. The communication manager 708 and/or the reception component 702 may receive second SCI indicative of a second reservation of the sidelink resource.

The communication manager 708 and/or the determination component 710 may determine, based on at least one COT associated with at least one of the first UE, the second UE, or an additional UE, a preemption status corresponding to the second reservation relative to the first reservation. In some aspects, the determination component 710 may include one or more antennas, a modem, a controller/processor, a memory, or a combination thereof, of the UE described in connection with FIG. 2. In some aspects, the determination component 710 may include the reception component 702 and/or the transmission component 704.

The communication manager 708, the reception component 702, and/or the transmission component 704 may perform a sidelink resource allocation operation based on the preemption status. The communication manager 708, the reception component 702, and/or the transmission component 704 may perform an LBT procedure, wherein performing the sidelink resource allocation operation comprises transmitting, based on a successful result of the LBT, a partial automatic gain control symbol in a first symbol of the sidelink resource. The communication manager 708, the reception component 702, and/or the transmission component 704 may perform an LBT procedure. The communication manager 708, the reception component 702, and/or the transmission component 704 may perform a resource selection procedure based on an unsuccessful result of the LBT procedure.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a first user equipment (UE), comprising: transmitting first sidelink control information (SCI) indicative of a first reservation, by the first UE for a first sidelink communication, of a sidelink resource corresponding to an unlicensed sidelink band; receiving second SCI indicative of a second reservation, by a second UE for a second sidelink communication, of the sidelink resource; determining, based on at least one channel occupancy time (COT) associated with at least one of the first UE, the second UE, or an additional UE, a preemption status corresponding to the second reservation relative to the first reservation; and performing a sidelink resource allocation operation based on the preemption status.

Aspect 2: The method of Aspect 1, wherein performing the sidelink resource allocation operation based on the preemption status comprises performing the sidelink resource allocation operation based on the first reservation being preempted by the second reservation.

Aspect 3: The method of Aspect 2, wherein the first reservation is preempted by the second reservation based on at least one preemption condition being satisfied.

Aspect 4: The method of Aspect 3, wherein the sidelink resource is not within the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on: the sidelink preemption enablement parameter having a first value, and the second priority level being higher than the first priority level.

Aspect 5: The method of Aspect 3, wherein the sidelink resource is outside the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on: the sidelink preemption enablement parameter having a third priority level, the second priority level being higher than the first priority level, and the second priority level being higher than the third priority level.

Aspect 6: The method of Aspect 3, wherein the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on: the sidelink preemption enablement parameter having a first value, and the second priority level being higher than the first priority level.

Aspect 7: The method of Aspect 3, wherein the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on: the sidelink preemption enablement parameter having a third priority level, the second priority level being higher than the first priority level, and the second priority level being higher than the third priority level.

Aspect 8: The method of any of Aspects 3-7, wherein the at least one preemption condition is satisfied based on the sidelink resource being included in the at least one COT, wherein the at least one COT comprises at least one of a COT associated with the second UE or a COT shared by the second UE.

Aspect 9: The method of Aspect 8, wherein the second SCI comprises a dedicated data field that indicates that the sidelink resource is in the at least one COT.

Aspect 10: The method of any of Aspects 2-9, wherein performing the sidelink resource allocation operation comprises: removing the sidelink resource from a first resource selection window based on the sidelink resource being preempted by the second UE; and determining a selected resource from a set of candidate resources in a second resource selection window, wherein the selected resource is included in the at least one COT, wherein the at least one COT comprises at least one of a COT associated with the first UE or a COT shared by the first UE.

Aspect 11: The method of any of Aspects 2-9, wherein performing the sidelink resource allocation operation comprises: removing the sidelink resource from a first resource selection window based on the reserved resource being preempted by the second UE; and determining a selected resource from a set of candidate resources in a second resource selection window, wherein the selected resource is outside the at least one COT, wherein the at least one COT comprises at least one of a COT associated with the first UE or a COT shared by the first UE.

Aspect 12: The method of Aspect 2, wherein performing the sidelink resource allocation operation based on the preemption status comprises performing the sidelink resource allocation operation based on the first reservation not being preempted by the second reservation.

Aspect 13: The method of Aspect 12, wherein the first reservation is not preempted by the second reservation based on the sidelink resource being outside the at least one COT, wherein the at least one COT consists of every COT associated with the second UE and every COT shared by the second UE.

Aspect 14: The method of any of Aspects 1-13, wherein the first sidelink communication is associated with a first starting time and the second sidelink communication is associated with a second starting time.

Aspect 15: The method of Aspect 14, wherein the second starting time corresponds to a beginning of the sidelink resource and wherein the first starting time corresponds to an offset from the beginning of the sidelink resource.

Aspect 16: The method of Aspect 15, wherein the second sidelink communication corresponds to a transmission time that at least partially overlaps the offset based on a successful listen before talk procedure associated with the second UE.

Aspect 17: The method of any of Aspects 1-16, further comprising performing a listen before talk (LBT) procedure, wherein performing the sidelink resource allocation operation comprises transmitting, based on a successful result of the LBT, a partial automatic gain control symbol in a first symbol of the sidelink resource.

Aspect 18: The method of any of Aspects 1-16, further comprising: performing a listen before talk (LBT) procedure; and performing a resource selection procedure based on an unsuccessful result of the LBT procedure.

Aspect 19: The method of Aspect 18, wherein the resource selection procedure is triggered in a reference slot, the method further comprising: identifying a set of candidate resources in a resource selection window comprising a window opening time and a window closing time, wherein the window opening time corresponds to a first time period after the reference slot and the window closing time corresponds to a second time period after the reference slot, and wherein the second time period has a length that is no smaller than a minimum value and no larger than a remaining packet delay budget; and determining a selected resource from the set of candidate resources.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
transmit first sidelink control information (SCI) indicative of a first reservation, by the first UE for a first sidelink communication, of a sidelink resource corresponding to an unlicensed sidelink band;
receive second SCI indicative of a second reservation, by a second UE for a second sidelink communication, of the sidelink resource;
determine, based on at least one channel occupancy time (COT) associated with at least one of the first UE, the second UE, or an additional UE, a preemption status corresponding to the second reservation relative to the first reservation; and
perform a sidelink resource allocation operation based on the preemption status.

2. The first UE of claim 1, wherein the one or more processors, to perform the sidelink resource allocation operation based on the preemption status, are configured to perform the sidelink resource allocation operation based on the first reservation being preempted by the second reservation.

3. The first UE of claim 2, wherein the first reservation is preempted by the second reservation based on at least one preemption condition being satisfied.

4. The first UE of claim 3, wherein the sidelink resource is not within the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on:
the sidelink preemption enablement parameter having a first value, and
the second priority level being higher than the first priority level.

5. The first UE of claim 3, wherein the sidelink resource is outside the at least one COT, wherein the at least one COT consists of every COT associated with the first UE and every COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on:
the sidelink preemption enablement parameter having a third priority level,
the second priority level being higher than the first priority level, and
the second priority level being higher than the third priority level.

6. The first UE of claim 3, wherein the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on:
the sidelink preemption enablement parameter having a first value, and
the second priority level being higher than the first priority level.

7. The first UE of claim 3, wherein the sidelink resource is included in the at least one COT, wherein the at least one COT comprises at least one of a COT associated with the first UE or a COT shared by the first UE, wherein a priority of the first sidelink communication has a first priority level and a priority of the second sidelink communication has a second priority level, wherein the first UE is configured with a sidelink preemption enablement parameter, and wherein the at least one preemption condition is satisfied based on:
the sidelink preemption enablement parameter having a third priority level,
the second priority level being higher than the first priority level, and
the second priority level being higher than the third priority level.

8. The first UE of claim 3, wherein the at least one preemption condition is satisfied based on the sidelink resource being included in the at least one COT, wherein the at least one COT comprises at least one of a COT associated with the second UE or a COT shared by the second UE.

9. The first UE of claim 8, wherein the second SCI comprises a dedicated data field that indicates that the sidelink resource is in the at least one COT.

10. The first UE of claim 2, wherein the one or more processors, to perform the sidelink resource allocation operation, are configured to:
remove the sidelink resource from a first resource selection window based on the sidelink resource being preempted by the second UE; and
determine a selected resource from a set of candidate resources in a second resource selection window, wherein the selected resource is included in the at least one COT, wherein the at least one COT comprises at least one of a COT associated with the first UE or a COT shared by the first UE.

11. The first UE of claim 2, wherein the one or more processors, to perform the sidelink resource allocation operation, are configured to:
remove the sidelink resource from a first resource selection window based on the reserved resource being preempted by the second UE; and
determine a selected resource from a set of candidate resources in a second resource selection window, wherein the selected resource is outside the at least one COT, wherein the at least one COT comprises at least one of a COT associated with the first UE or a COT shared by the first UE.

12. The first UE of claim 2, wherein the one or more processors, to perform the sidelink resource allocation operation based on the preemption status, are configured to perform the sidelink resource allocation operation based on the first reservation not being preempted by the second reservation.

13. The first UE of claim 12, wherein the first reservation is not preempted by the second reservation based on the sidelink resource being outside the at least one COT, wherein the at least one COT consists of every COT associated with the second UE and every COT shared by the second UE.

14. The first UE of claim 1, wherein the first sidelink communication is associated with a first starting time and the second sidelink communication is associated with a second starting time.

15. The first UE of claim 14, wherein the second starting time corresponds to a beginning of the sidelink resource and wherein the first starting time corresponds to an offset from the beginning of the sidelink resource.

16. The first UE of claim 15, wherein the second sidelink communication corresponds to a transmission time that at least partially overlaps the offset based on a successful listen before talk procedure associated with the second UE.

17. The first UE of claim 1, wherein the one or more processors are further configured to perform a listen before talk (LBT) procedure, and wherein the one or more processors, to perform the sidelink resource allocation operation, are configured to transmit, based on a successful result of the LBT, a partial automatic gain control symbol in a first symbol of the sidelink resource.

18. The first UE of claim 1, wherein the one or more processors are further configured to:
perform a listen before talk (LBT) procedure; and
perform a resource selection procedure based on an unsuccessful result of the LBT procedure.

19. The first UE of claim 18, wherein the resource selection procedure is triggered in a reference slot, and wherein the one or more processors are further configured to:
identify a set of candidate resources in a resource selection window comprising a window opening time and a window closing time, wherein the window opening time corresponds to a first time period after the reference slot and the window closing time corresponds to a second time period after the reference slot, and wherein the second time period has a length that is no smaller than a minimum value and no larger than a remaining packet delay budget; and
determine a selected resource from the set of candidate resources.

20. A method of wireless communication performed by a first user equipment (UE), comprising:
transmitting first sidelink control information (SCI) indicative of a first reservation, by the first UE for a first sidelink communication, of a sidelink resource corresponding to an unlicensed sidelink band;
receiving second SCI indicative of a second reservation, by a second UE for a second sidelink communication, of the sidelink resource;
determining, based on at least one channel occupancy time (COT) associated with at least one of the first UE, the second UE, or an additional UE, a preemption status corresponding to the second reservation relative to the first reservation; and
performing a sidelink resource allocation operation based on the preemption status.

21. The method of claim 20, wherein performing the sidelink resource allocation operation based on the preemption status comprises performing the sidelink resource allocation operation based on the first reservation being preempted by the second reservation.

22. The method of claim 21, wherein the first reservation is preempted by the second reservation based on at least one preemption condition being satisfied.

23. The method of claim 22, wherein the at least one preemption condition is satisfied based on the sidelink resource being included in the at least one COT, wherein the at least one COT comprises at least one of a COT associated with the second UE or a COT shared by the second UE.

24. The method of claim 21, wherein performing the sidelink resource allocation operation comprises:
removing the sidelink resource from a first resource selection window based on the sidelink resource being preempted by the second UE; and
determining a selected resource from a set of candidate resources in a second resource selection window, wherein the selected resource is included in the at least one COT, wherein the at least one COT comprises at least one of a COT associated with the first UE or a COT shared by the first UE.

25. The method of claim 21, wherein performing the sidelink resource allocation operation comprises:
removing the sidelink resource from a first resource selection window based on the reserved resource being preempted by the second UE; and
determining a selected resource from a set of candidate resources in a second resource selection window, wherein the selected resource is outside the at least one COT, wherein the at least one COT comprises at least one of a COT associated with the first UE or a COT shared by the first UE.

26. The method of claim 20, wherein the first sidelink communication is associated with a first starting time and the second sidelink communication is associated with a second starting time, and wherein the second starting time corresponds to a beginning of the sidelink resource and wherein the first starting time corresponds to an offset from the beginning of the sidelink resource.

27. An apparatus for wireless communication, comprising:
means for transmitting first sidelink control information (SCI) indicative of a first reservation, by the apparatus for a first sidelink communication, of a sidelink resource corresponding to an unlicensed sidelink band;
means for receiving second SCI indicative of a second reservation, by a UE for a second sidelink communication, of the sidelink resource;
means for determining, based on at least one channel occupancy time (COT) associated with at least one of the apparatus, the UE, or an additional UE, a preemption status corresponding to the second reservation relative to the first reservation; and
means for performing a sidelink resource allocation operation based on the preemption status.

28. The apparatus of claim 27, wherein the means for performing the sidelink resource allocation operation based on the preemption status comprises means for performing the sidelink resource allocation operation based on the first reservation being preempted by the second reservation.

29. A non-transitory computer-readable medium storing a set of instructions for wireless communication, the set of instructions comprising:
one or more instructions that, when executed by one or more processors of a first user equipment (UE), cause the UE to:
transmit first sidelink control information (SCI) indicative of a first reservation, by the first UE for a first sidelink communication, of a sidelink resource corresponding to an unlicensed sidelink band;
receive second SCI indicative of a second reservation, by a second UE for a second sidelink communication, of the sidelink resource;
determine, based on at least one channel occupancy time (COT) associated with at least one of the first UE, the second UE, or an additional UE, a preemption status corresponding to the second reservation relative to the first reservation; and
perform a sidelink resource allocation operation based on the preemption status.

30. The non-transitory computer-readable medium of claim 29, wherein the one or more instructions, that cause the UE to perform the sidelink resource allocation operation based on the preemption status, cause the UE to perform the sidelink resource allocation operation based on the first reservation being preempted by the second reservation.
